(19) United States
(12) Patent Application Publication
(10) Pub. No.: US 2006/0249601 A1
(43) Pub. Date: Nov. 9, 2006

(54) Fuel injection valve

(76) Inventor: Franz Thoemmes, Bietigheim-Bissingen (DE)

Correspondence Address: KENYON & KENYON LLP, ONE BROADWAY, NEW YORK, NY, 10004, US

(21) Appl. No.: 10/564,226

(22) PCT Filed: Jun. 19, 2004
(86) PCT No.: PCT/DE04/01286

§ 371 Date: May 31, 2006

(30) Foreign Application Priority Data
Jul. 16, 2003 (DE) 103 32 348.1

(51) Int. Cl. F02M 51/00

(52) U.S. Cl. 239/585.4; 239/585.1; 239/900; 239/600

(57) ABSTRACT

A fuel injector includes a solenoid coil, which cooperates with an armature acted upon by a restoring spring, the armature forming an axially movable valve part together with a valve needle. A valve-closure member which forms a sealing seat together with a valve-seat body is provided on the valve needle. In addition, a valve sleeve is provided whose wall thickness varies across its axial extension.

### BACKGROUND INFORMATION

Described in German Patent Application No. DE 40 03 227, for instance, is a fuel injector, which has a core enclosed by a solenoid coil; an armature via which a valve closure body cooperating with a fixed valve seat is actuable by a connection pipe soldered to the armature; and a tubular metal intermediate part, which is sealingly connected by welding to an end of the core facing the armature by its one end and to a tubular connecting part by its other end; and at least one bracket-type conductive element which crosses over the solenoid coil and is connected, by welding, to the connecting part by its end facing the valve closure member and to the core by its other end. The welding of two overlapping components of the fuel injector is implemented in a cross-section reduction of one of the two parts to be welded.

A particular disadvantage of the fuel injector known from the aforementioned printed publications is that the production of the connections between the individual components of the fuel injector is complicated and thus time- and cost-intensive. Furthermore, the welded points are loaded thermally and thus lose their strength and flexural stiffness which may lead to considerable resonances as a result of housing parts having different thicknesses and to related noise development during operation of the fuel injector.

### SUMMARY OF THE INVENTION

The fuel injector according to the present invention has the advantage that the wall thickness of the valve sleeve of the fuel injector varies. As a result, it is adapted to the specific requirements in the various regions. Resonances are attenuated so that the noise development is dampened as well. This has no negative effect on the stability of the valve sleeve and the saturation behavior of the magnetic field in the region of the working air gap.

In an advantageous manner the wall thickness is reduced in a discharge direction of the fuel, so that the relevant parts do not suffer any loss in stability.

It is also advantageous that the valve sleeve diameter also tapers in the region of the reduced wall thickness, which makes the fuel injector more compact and lighter.

Furthermore, it is advantageous that the supply pipe which conveys the fuel to the sealing seat may be formed in one piece with the valve sleeve, so that the fuel injector may likewise have a more compact and shorter design.

### BRIEF DESCRIPTION OF THE DRAWING

FIG. 1 shows a schematic section through an exemplary embodiment of a fuel injector configured according to the present invention.

### DETAILED DESCRIPTION

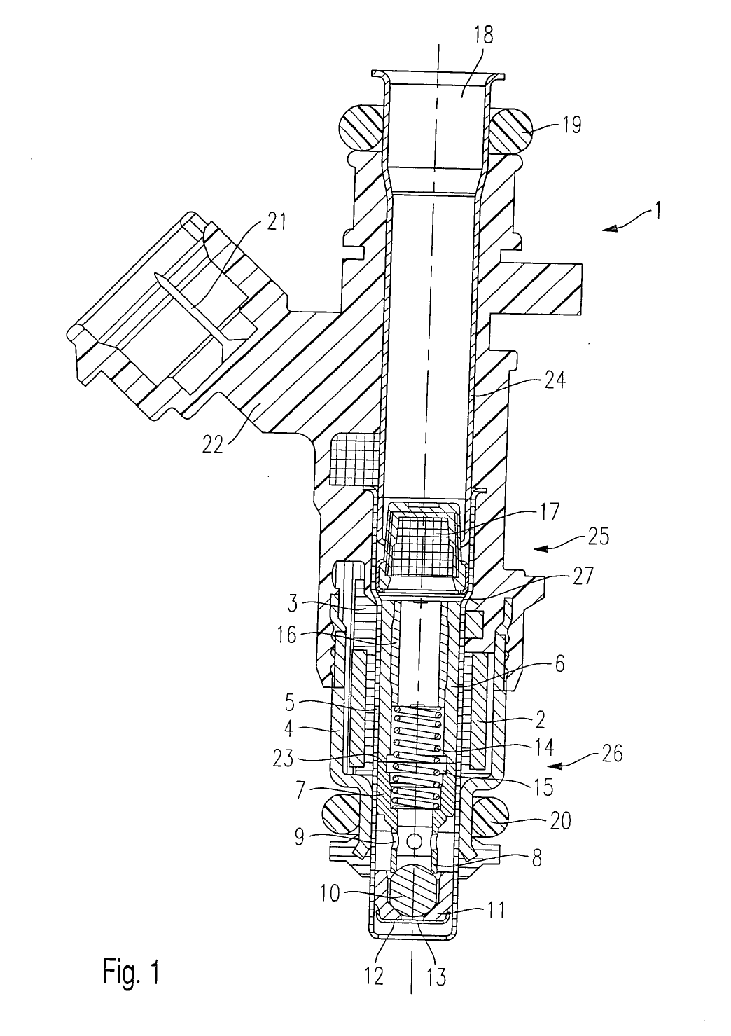

FIG. 1 shows a sectional, schematic representation of a longitudinal section through an exemplary embodiment of a fuel injector 1 designed according to the present invention, the fuel injector being suited, in particular, for the injection of fuel into an intake manifold (not shown further) of an internal combustion engine.

Fuel injector 1 includes a solenoid coil 2 which is wound on a coil brace 3. Coil brace 3 is encapsulated in a cup-shaped valve housing 4.

Coil brace 3 is penetrated by a valve sleeve 5 which has a tubular design and according to the present invention varies in its material thickness. The measures of the present invention will be described in greater detail below.

A support pipe 6 wedged inside or welded to valve sleeve 5 may be used as inner pole of solenoid coil 2. Valve housing 4, for example, may be used as outer pole of solenoid coil 2. Downstream from support pipe 6 is an armature 7 which is integrally formed with a valve needle 8. Flow-through orifices 9, which guide the fuel flowing through fuel injector 1 toward a sealing seat, are provided in valve needle 8.

Valve needle 8 is in operative connection—preferably by welding—with a valve-closure member 10 which has a spherical shape in the exemplary embodiment and forms a sealing seat together with a valve-seat body 11. Downstream from the sealing seat, at least one spray-discharge orifice 13 is formed in a spray-orifice plate 12, from which the fuel is injected into the intake manifold (not shown further).

In the rest state of fuel injector 1, armature 7 is acted upon by a restoring spring 14 in such a way that fuel injector 1 is held closed by the contact pressure of valve-closure member 10 on valve-seat body 11. Restoring spring 14 is situated in a recess 15 of armature 7 or support pipe 6 and is prestressed by an adjusting sleeve 16. On the inflow side of adjusting sleeve 16, a cup-shaped filter element 17 is preferably pressed into valve sleeve 5. Via an intake pipe 24, a recess 15 and flow-through orifices 9, the fuel conveyed by a central fuel supply 18 flows through fuel injector 1 to the sealing seat and to spray-discharge orifice 13.

For the purpose of installation on a fuel-distributor line (not shown further), fuel injector 1 is provided with a seal 19 in the region of central fuel supply 18. An additional seal 20 seals the connection (not shown further) between fuel injector 1 and the intake manifold. Solenoid coil 2 is energized via a line by an electric current, which may be supplied via an electrical plug contact 21. Plug contact 21 is enclosed by a plastic coating 22 which may be sprayed onto valve sleeve 5 or onto intake pipe 24.

If an electric current is supplied to magnetic coil 2 via an electrical line (not shown further), a magnetic field will be generated that, if sufficiently strong, pulls armature 7 into magnetic coil 2, counter to the force of restoring spring 14 and counter to the flow direction of the fuel. This closes a working gap 23 formed between armature 7 and support pipe 6. The movement of armature 7 also carries along in the lift direction valve needle 8 integrally formed with armature 7, so that valve-closure member 10 lifts off from valve-seat body 11 and fuel is conveyed to spray-discharge orifice 13.

Fuel injector 1 is closed as soon as the electric current energizing magnetic coil 2 has been switched off and the magnetic field has decayed to such a degree that restoring spring 14 presses armature 7 away from support pipe 6, thereby moving valve needle 8 in the discharge direction and valve-closure member 10 coming to rest on valve-seat body 11.

Due to flexural vibrations, fuel injectors have a tendency to emit interfering noise during operation. This is caused by the form of valve sleeve 5 which has a support function on the one hand, but on the other hand must be thin enough in its material thickness to allow a satisfactory build-up of the magnetic field in the region of the working air gap.

As mentioned above, valve sleeve 5 has a tubular design and according to the present invention varies in its wall thickness in order to limit noise emissions. An inflow-side region 25 into which supply pipe 24 is inserted, has a heavier design than a downstream region 26. The wall thickness of valve sleeve 5 in the inflow-side region is approximately 0.5 mm, while the downstream region has a wall thickness of approximately 0.3 mm.

In addition, the cross section of valve sleeve 5 is variable as well. In region 25 having greater material strength the cross section is larger, which leads to higher stability of valve sleeve 5; the cross section is smaller in region 26 having lower material strength.

The tapering of valve sleeve 5 occurs at a collar 27 which separates the regions having high material thickness and those having low material thickness and also the regions having different cross sections.

Due to the greater wall thickness of inflow-side region 25 of valve sleeve 5, it may also be formed in one piece with supply pipe 24, which constitutes an advantageous further development of fuel injector 1 with respect to compactness and overall length.

The present invention is not limited to the exemplary embodiment shown. In particular, any combination of the individual features is possible.

1-7. (canceled)

8. A fuel injector comprising:
a valve needle;
an armature forming an axially movable valve part together with the valve needle;
a restoring spring acting upon the armature;
a magnetic coil cooperating with the armature;
a valve-seat body;
a valve-closure member, which forms a sealing seat with the valve-seat body, being provided on the valve needle; and
a valve sleeve surrounding the armature and the valve needle, a wall thickness of the valve sleeve varying across its axial extension.

9. The fuel injector according to claim 8, wherein the wall thickness of the valve sleeve decreases in a discharge direction of a fuel.

10. The fuel injector according to claim 8, wherein the wall thickness of the valve sleeve is about 0.5 mm in an inflow-side region.

11. The fuel injector according to claim 10, further comprising a supply pipe inserted into the valve sleeve in the inflow-side region.

12. The fuel injector according to claim 10, further comprising a supply pipe integrally formed with the valve sleeve.

13. The fuel injector according to claim 10, wherein a radial cross section of the valve sleeve decreases between the inflow-side region and a discharge-side region on a collar.

14. The fuel injector according to claim 13, wherein the wall thickness of the valve sleeve is about 0.3 mm in a discharge-side region.
